(19) United States
(12) Patent Application Publication
(10) Pub. No.: US 2008/0288590 A1
(43) Pub. Date: Nov. 20, 2008

(54) ONLINE COACHING SYSTEM AND METHOD

(76) Inventor: Martin Lynch, Oak Brook, IL (US)

Correspondence Address: POLSTER, LIEDER, WOODRUFF & LUCCHESI, 12412 POWERSCOURT DRIVE SUITE 200, ST. LOUIS, MO, 63131-3615, US

(21) Appl. No.: 12/122,919

(22) Filed: May 19, 2008

Related U.S. Application Data
(60) Provisional application No. 60/938,918, filed on May 18, 2007.

(51) Int. Cl. G06F 15/16

(52) U.S. Cl. 709/204

(57) ABSTRACT

A method of coaching through a computer system having at least two client devices, and a communication network operatively and electrically connecting the client devices to the at least one server. A user generates at a client device a sports diagram representing a playing surface with sports plays and transmits the sports diagram to another client device via a server for display. The user can also communicate analysis of the diagram between the two client devices.

### CROSS-REFERENCE TO RELATED APPLICATIONS

This application is related to U.S. Provisional Patent Application No. 60/938,918 filed Apr. 18, 2007 from which priority is claimed, and is hereby incorporated by reference.

### STATEMENT REGARDING FEDERALLY SPONSORED RESEARCH

Not Applicable.

### BACKGROUND OF THE INVENTION

This invention relates to an online coaching system and method and, more particularly, to an online coaching system and method for sports between a coach and players.

At all levels of sports, a teams success during the game largely depends on its pre-game and post-game preparation. In addition to regular practice, today's players and coaches must also be students of the game. This additional preparation includes instruction, communication, and collaboration between the coaches and players to study plays, strategies, and game plans.

Busy schedules, vacations, school breaks, and travel often make it difficult to physically assemble players of an entire team in one place for classroom-type meetings. This limits the coaches ability to properly prepare and instruct a team before and after games. Therefore, there is a long felt need for a method and apparatus for collaborative coaching sessions through electronic media where the coach is at one locations and the players are in other multiple locations.

### DESCRIPTION OF THE DRAWINGS

In the accompanying drawings which form part of the specification:

FIG. 1 a block diagram of a system for administrating a coaching system in accordance with the present invention;

FIG. 2 is a sample homepage appearing on the display of the client device;

FIG. 3 is a sample registration form appearing on the display of the client device;

FIG. 4 is sample instruction webpage appearing on the display of the client device; and

FIG. 5 is a sample sketching webpage appearing on the display of the client device.

Corresponding reference numerals indicate corresponding parts throughout the several figures of the drawings.

### DETAILED DESCRIPTION

The following detailed description illustrates the invention by way of example and not by way of limitation. The description clearly enables one skilled in the art to make and use the invention, describes several embodiments, adaptations, variations, alternatives, and uses of the invention, including what is presently believed to be the best mode of carrying out the invention. Additionally, it is to be understood that the invention is not limited in its application to the details of construction and the arrangements of components set forth in the following description or illustrated in the drawings. The invention is capable of other embodiments and of being practiced or being carried out in various ways. Also, it is to be understood that the phraseology and terminology used herein is for the purpose of description and should not be regarded as limiting.

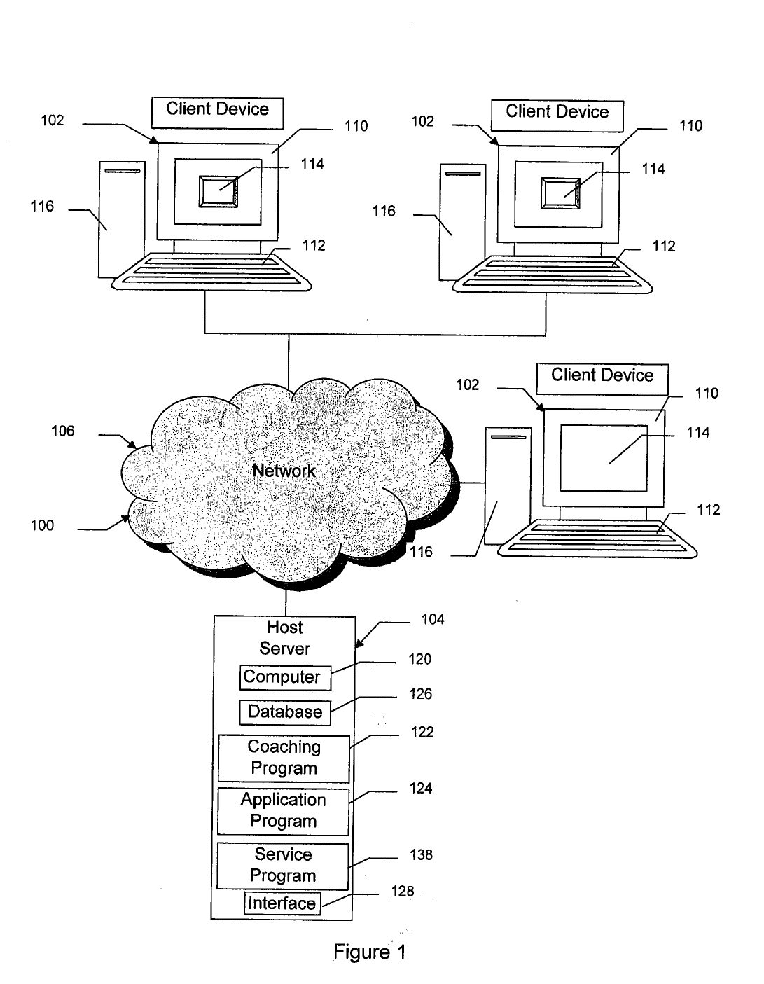

As shown in FIG. 1, an embodiment of the present invention, generally referred to as a computer system 100, includes at least one client device 102 operatively connected to at least one host server 104 through a communication network 106 to communicate data between the client device 102 and the host server 104. The computer system 100 is capable of administering a coaching program 122, which is described below in further detail.

In the embodiment of FIG. 1, the client device 102 is a computer 108, including a processor, memory, a mass storage device, a display device 110, and an input device 112, such as a keyboard, that is capable of running a network interfacing program 114, such as web browser software available, for example, from Netscape® Corporation, Apple® Corporation, or from Microsoft® Corporation. The client device 102 is appropriately equipped with a network interfacing device 116 for communicating data with the network 106, such as a dial-up modem, a cable modem, a satellite connection, a DSL (Digital Subscriber Line) connection, a LAN (Local Area Network), or the like.

Alternate embodiments of client device 102 include any electrical or electronic device capable of communicating with the server 104 through the network 106, such as, for example, a personal digital assistant (PDA), cellular phone, a telephone operating with an interactive voice-system, or a television operating with a cable or satellite television interactive system.

A user interacts with the client device 102 by viewing data via the display 110 and entering data via the keyboard 112, or other suitable input interface such as a mouse, microphone, touch screen, and the like. The network interfacing program 114 allows the user to enter addresses of specific web pages to be retrieved, which are referred to as Uniform Resource Locators, or URLs. The web pages can contain various types of content from plain textual information to more complex multimedia and interactive content, such as software programs, graphics, audio signals, videos, and so forth. A set of interconnected web pages, usually including a homepage, are managed on a server device as a collection collectively referred to as a website. The content and operation of such websites are managed by the server device, such as host server 104, which is operatively connected to the network 106.

In the embodiment of FIG. 1, the network 106 is the Internet, which uses a suitable communications protocol, such as HyperText Transfer Protocol (HTTP), to communicate data between the client devices 102 and the host server 104. However, the network 106 can be any network that allows an exchange of data between the client devices 102 and the host server 104, such as a LAN or WAN (Wide Area Network). In addition, any suitable type of communications protocol can be used, such as FTP (File Transfer Protocol), SNMP (Simple Network Management Protocol), TELNET (Telephone Network), and the like.

The host server 104 preferably comprises a computer system 120, having a processor, memory, and a mass storage device, which is capable of running a coaching program 122. A database 126 is stored on the mass storage device. Also, the host server 104 is appropriately equipped with a network interfacing device 128 for communicating data with the network 106, such as a dial-up modem, a cable modem, a satellite connection, a DSL connection, a LAN, or the like. If necessary to accommodate large amounts of information or run numerous applications, alternate embodiments of the host server 104 can comprise multiple computer systems, multiple databases, or any combination thereof.

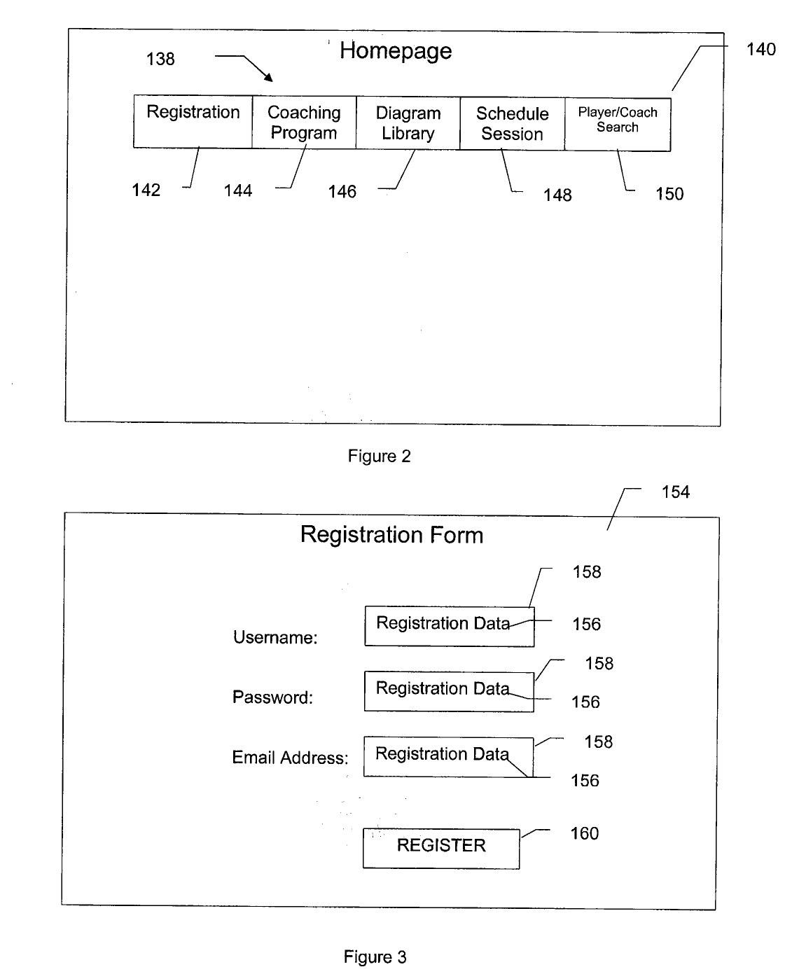

An application program 124 allows users through the interfacing program 114 of the client device 102 to access the coaching program 122 and various service programs 138 on the host server 104. As shown in FIGS. 1 and 2, the application program 124 generates a web page, such as home page 140, that transmits through the network 106 and displays on the client device display 110 via the interfacing program 114. In the preferred embodiment, the home page 140 includes a menu of the various service programs 138 including Registration 142, Coaching Program 122, Diagram Library 146, Schedule Session 148, and Coach/Player Search 150. The user interacts with the application program 124 by entering data with the input device 112, in this case by selecting the coaching program 122 or one of the service programs 138. By selecting one of these options, the application program 124 generates additional web pages and interacts with the database 126 and the client device 102 in order to provide the selected programs to the user.

The operation of the system 100 begins with the step of registering a group of users as participants. To register, a user utilizes the client device 102 to access the home page 140 and select Registration 142, which displays the web page registration form 154 shown in FIG. 3 to the user on the display 110 of the client device 102. Using the keyboard 112, the user enters registration data 156 into the fields 158 of the registration form 154, which can include, but is not limited to a Username, a Password, an Email address, Club, Role, Experience, ISP, Computer type, League Affiliation, Meeting Frequency, and other demographic information. After entering the registration data 156, the user presses the “Register” button 160 to electronically transfer the registration data 156 through the network 106 to the host server 104. The registration data 156 is recorded in a master account on the database 126, so that the host server 104 can identify the user as a participant and track personalized settings. For example, the registration data 156 can be used to determine each participants level of access to the programs, the participants associated team, access to any special features, affinity groups for marketing services, security profile, and other features.

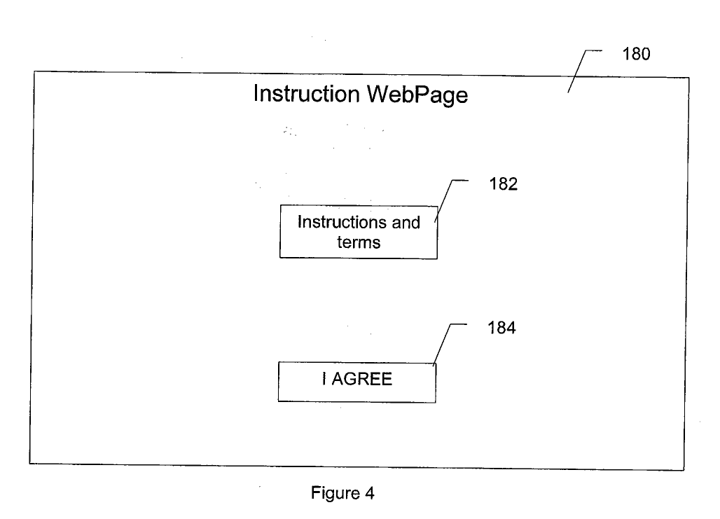

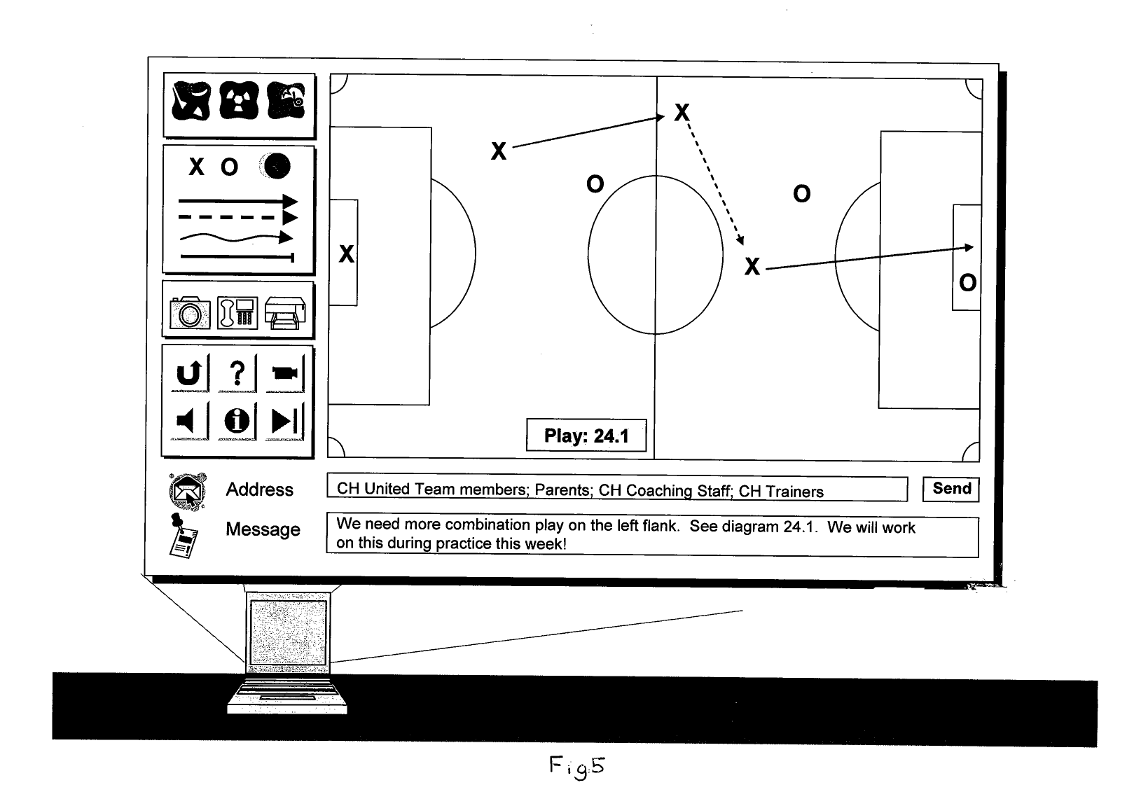

Subsequently, the host server 104 displays an instruction webpage 180 to the participant on the display 110 of the client device 102 with instructions and the terms 182 for use of the coaching program 122 (FIG. 4). The host server 104 can also display to the participant on the display 110 a requirement that the registrant affirm by pressing an “I Agree” button 184 or similar confirmation button that he or she agrees to the expressed terms.

To confirm registration of the participant, the host server 104 sends an electronic message through the network 106 to the appropriate client device 102 using the stored email address. The message includes all of the registration data 156 of the registrants master account stored on the database 126 so that the registrant can review the registration data 156 for any errors.

After completing registration, the user is provided with access to the coaching program 122 and service programs 138 by the application program 124. Each time the user accesses the homepage 140 of the host server 104 through the client device 102, the application program 124 confirms that the user is a registered participant. This can be done by a manual or automatic login procedure, which requires the user to provide the username and password associated with their master account.

The coaching program 122 allows a group of participants through the interfacing program 114 of each client device 102 to access the host server 104 simultaneously to collaborate for a coaching session. Each group of participants designates a session facilitator that is responsible for scheduling and managing a session. The session facilitator utilizes the client device 102 to access the home page 140 and select schedule session 148 to enter a selected time and date for a coaching session (FIG. 2). The host server 104 notifies the group participants of the selected time and date by email. The host server 104 can include voting buttons within each email for participants to respond about whether they will participate in the scheduled coaching session.

At the selected time and date, the session facilitator utilizes the client device 102 to access the home page 140 and select the coaching program 122. Other group participants utilize the other client devices 102 to access the home page 140 and select the coaching program 122. The host server 104 transmits the coaching program 122, in the form of a web page 136 as shown in FIG. 5, to each client device 102, where it is displayed on each display 110. The client device 102 for the session facilitator displays a facilitator console that provides the session facilitator with control and access of all of the coaching program 122 features. The client devices 102 for the other group participants display a participant console that provides limited access to the coaching program 122 features so that the participant console is subservient to the facilitator console. This arrangement allows the session facilitator to control and manage the session.

The coaching program 122 displays a sketchpad feature in the form of a web page 136 as shown in FIG. 5, to each client device 102, where it is displayed on each display 110. Using the input device 112, the session facilitator selects from various buttons # to sketch diagrams that appear on the display 110. For example, the session facilitator can select layouts from different sports, such as baseball, soccer, basketball, football, tennis, volleyball, hockey, rugby, field hockey, lacrosse, cricket, dodgeball, or other sports. In addition, the session facilitator can select player icons, such as X's or O's, running and passing lines, or moving ball icons. Moreover, the session facilitator can erase, redraw, and animate the diagrams. Different diagrams, icons, and lines can be individualized using different colors or labels. During animation, trails or shadows can be displayed to allow participants to easily track the movement of the icons.

The coaching program 122 can also include other features. For example, video clips can be imported and associated with sessions. The coaching program 122 can maintain a searchable directory of coaches and players. In addition, the coaching program can maintain a profile for each player including a number of attributes, such as team, family, coach, interests, plays, stats, picture, and the like. The player profiles can be accessible through the sketchpad feature. Moreover, the player profiles enable each group participant involved in a session to view the coaching program 122 on their display 110 with a personalized webpage corresponding to their player profile. In this way, the group participant can view a diagram through their own point-of-view.

The host server 104 can include a library of diagrams stored on the database 126 of the host server 104 that can be accessed by group participants. The diagrams can be searched using various parameters, such as title, author, date, session number, content of minutes, and the like. Once selected, a group participant can view, edit, or animate the selected diagram. These diagrams can also incorporate information from the player profiles. Diagrams can be stored on the database 126 to the library for access at a later time by the group participants or others. For example, a coach can create and store a personalized playbook of diagrams.

During a session, the session facilitator and the group participants can communicate through the host server 104 in various ways. For example, host server 104 can facilitate one-way voice communication between one participant, such as the session facilitator, and all the other participants using internet broadcasting or other related technology. The host server 104 can also provide synchronous voice communication between multiple participants using appropriate technology, such as WebEx™, voice over internet protocol, and the like. Other forms of communication can be incorporated into the host server 104, including, but not limited to, instant messaging, discussion threads, email, and video communication. Some or all of these services can be provided through third party providers.

To control the flow of communication during the session, the session facilitator can enable a “Hand Raise” feature. When this feature is enabled, each client device 102 displays a “hand raise” button, which the participant presses to input a question or comment. The host server 104 displays an alert along with the question or comment to the facilitator console indicating which participant has pressed the “hand raise” button. The session facilitator can then respond to the participant's question or comment individually or to the entire participant group using any of the communication methods discussed above.

Before or after sessions, participants can access the host server 104 individually for self-study.

Access to the host server 104 can be sold in seasonal packages, such as spring, summer, fall, winter, or yearly. In addition, access to the host server 104 can be sold in packages of predetermined number of sessions, such as a package of five (5) or ten (10) sessions. However, those skilled in the art will recognize that access to the host server can be sold in any number of different ways, such as, packages or sessions.

Changes can be made in the above constructions without departing from the scope of the invention, it is intended that all matter contained in the above description or shown in the accompanying drawings shall be interpreted as illustrative and not in a limiting sense.

What is claimed is:

1. A method of administering a coaching program through a computer system having at least one server, at least two client devices, and a communication network operatively and electrically connecting the client devices to the at least one server, the method comprising the steps of:
accessing, by a group of users from the client devices, a coaching website running on the at least one server;
generating coaching data with the coaching program on the at least one server;
transmitting the coaching data to the at least one server;
transmitting the coaching data to the at least one client device; and
displaying the coaching data at the at least two client devices.

2. The method of claim 1, further comprising registering a group of users.

3. The method of claim 1, further comprising recording registration data in a master account on a database.

4. The method of claim 1, further comprising maintaining a profile of each user.

5. The method of claim 1, further comprising:
displaying the coaching data on an output device consisting of one of a television monitor, a personal computer monitor, personal digital assistant screen, or a cellular phone screen; and
wherein the client device is equipped with a network interfacing device including one of a dial-up modem, a satellite connection, a DSL connection, or a LAN.

6. The method of claim 1, further comprising designating a facilitator.

7. The method of claim 6, further comprising facilitating communication between the facilitator and at least one user.

8. The method of claim 1, further comprising providing a library of coaching data on the server that is accessible by the client devices.

9. A method of coaching, comprising the steps of:
providing a computer system having at least two client devices, and a communication network operatively and electrically connecting the client devices to the at least one server;
generating a sports diagram representing a playing surface with sports plays, by a user at a client device;
transmitting the sports diagram to the at least one server;
transmitting the sports diagram to at least one client device;
displaying the diagram on at least one client device; and
communicating analysis of the diagram between the at least two client devices.

10. The method of claim 9, further comprising:
storing a profile of each player on the team, the profile including player attributes including team, family, coach, interests, plays, statistics, or picture;
providing a sketchpad with player attributes being displayed on the sketchpad; and
diagramming a play using a selected layout for a sport, in which diagramming the play includes designating selected team members and their corresponding attributes for respective team positions shown on the diagram.

11. The method of claim 9, further comprising registering a group of users.

12. The method of claim 11, further comprising storing registration data in a master account on a database.

13. The method of claim 9, further comprising designating a facilitator.

14. The method of claim 13, further comprising facilitating communication between the facilitator and at least one user.

15. The method of claim 9, further comprising providing a library of coaching data on the server that is accessible by the client devices.
